(19) United States
(12) Patent Application Publication
(10) Pub. No.: US 2006/0037591 A1
(43) Pub. Date: Feb. 23, 2006

(54) System and method for increasing the available oxygen in a combustion engine

(76) Inventor: James L. Ferguson, Conifer, CO (US)

Correspondence Address: MARTIN & HENSON, P.C., 9250 W 5TH AVENUE, SUITE 200, LAKEWOOD, CO, 80226, US

(21) Appl. No.: 11/206,637

(22) Filed: Aug. 18, 2005

Related U.S. Application Data
(60) Provisional application No. 60/602,919, filed on Aug. 18, 2004.

(51) Int. Cl. F02M 25/10; F02B 23/00

(52) U.S. Cl. 123/567; 123/585

(57) ABSTRACT

A system and method for introducing auxiliary oxygen into a combustion engine employs a conduit to establish fluid communication between a source of auxiliary oxygen and at least one dispensing outlet that is associated with the intake assembly of the engine. A controllable valve is associated with the conduit and is operative to selectively vary the flow of oxygen to the intake assembly. A pressure regulator may be used to control the pressure at which the auxiliary oxygen is delivered. The valve may be switched, for example by a solenoid, between states permitting the flow of oxygen and prohibiting the flow of oxygen. The switch may be associated with a computerized engine control unit or mechanical throttle controls. An override switch may be connected in parallel with the valve switch, and an on/off master switch may be connect in series with the valve switch.

### FIELD OF INVENTION

The present invention is broadly directed to a system for improving the performance of an internal combustion engine. More particularly, the invention relates to a system for storing and introducing auxiliary oxygen into the fuel/air flow entering a combustion engine. The invention therefore further relates to a method of increasing the available oxygen for combustion engines.

### BACKGROUND OF THE INVENTION

The internal combustion engine is one of the most prevalent machines in our lives. The basic operation principle of these devices is to combine and ignite air (which contains oxygen) and fuel (gasoline, diesel, or other types) in a controlled explosion to provide mechanical work as the outcome. Since its invention, people have sought to improve the internal combustion engine's efficiency and performance.

One avenue that has been followed in this pursuit has been to increase the amount of oxygen delivered to the combustion chamber, thereby increasing the amount of energy released per combustion cycle. One approach to this has been to pressurize the incoming air thereby providing more oxygen per volume which, when combined with more fuel, yields more power. This is usually accomplished by adding a compressor, or pump, and a high pressure induction system to the engine.

A second, more mechanically simple, approach is motivated by the fact that air contains approximately 20% oxygen, the rest being nitrogen and other gases which play no power-producing role in the combustion process. A common way of increasing the oxygen content has been the addition of nitrous oxide (N₂O) gas to the incoming air stream. Since nitrous oxide contains a higher percentage of oxygen than air does, it provides more combustion energy per volume. The nitrous oxide is typically stored in liquid state in a tank and is injected into the engine's intake air stream thereby increasing the relative amount of oxygen. The injection of the N₂O into the engine is typically controllable by the driver or engine computer so that it can be deployed when extra power is required while the engine is under a moderate to heavy load. A system such as this consists of a pressure tank for storing the liquid N₂O, a control valve, hosing, control solenoids, switches, and one or more injectors. The injectors, or nozzles, are exit orifices positioned to disperse the N₂O into the air stream and induce the rapid expansion of the nitrous oxide liquid into a gaseous state for its mixing with the intake air. Pressure tank heaters are also commonly employed to maintain a high enough tank temperature to insure that the pressure in the supply line is sufficient to provide the vaporization of the N₂O when injected into the engine's air stream.

While this approach is able to provide power output increases when applied to an engine, it is not without some drawbacks, one of these being that the cost of N₂O is significant and it is not always readily available. Another drawback to N₂O injection is that the system requires purging of any gaseous nitrous oxide from the supply hoses after a period of non-use. For consistent power application and control the N₂O supply line needs to contain only the liquid state of N₂O when the system is employed. Still another problem with N₂O injection is that the injector nozzles must be selectively sized for the amount of added power desired, one cannot simply change the nitrous oxide supply pressure to alter the amount of N₂O injected. As a result, N₂O injection has been used primarily for racing applications where one is seeking to obtain as much power increase as possible while the engine is operating at wide open throttle.

The present invention seeks to improve on the approach of enriching the oxygen content of the intake air by instead introducing auxiliary oxygen gas (O₂) into the engine's intake air. Compressed oxygen is more readily available than N₂O and, since only oxygen is added to the air, it is consumed in the combustion process with no more nitrogen-based pollutants being released than in a non-oxygen injected engine. In addition, a pressure tank heater is not required; the compressed oxygen can be stored at a high enough pressure to maintain the minimum pressure drop required for consistently controllable flow. Since the present invention utilizes gaseous oxygen from storage through to its outlet, there is no need to purge the supply line before its use as is the case with N₂O injection.

The present invention does not require special nozzles for the introduction of the oxygen into the intake air since it uses the regulated oxygen tank pressure to control the rate of flow introduced into the engine so increasing the supply pressure at the tank increases the oxygen content of the combustion gas, and hence the added performance, while decreasing the supply pressure decreases the content. Because of this, the present invention is well suited to applications where one would put a premium on the aspect of control of the power increase such as in situations where one is towing heavy loads with a car or truck.

Another useful application of the present invention involves the injection of oxygen as a means for leaning the combustion mixture. An engine's efficiency and overall performance is dictated by the ratio of fuel to oxygen. An engine tends to work best when this ratio is within a specific range. By adding more oxygen to the intake air and displacing nitrogen (which does not participate in the combustion) while maintaining the same amount of fuel flow, the mixture will become leaner. Therefore, vehicles which tend to run rich (too much fuel with respect to the amount of air) can be altered to run leaner by the introduction of auxiliary oxygen.

### SUMMARY

It is an object of the present invention to provide an apparatus and method adapted to store and deliver auxiliary oxygen gas into the fuel/air intake of an internal combustion engine.

An aspect of the exemplary embodiments allows the flow rate of added auxiliary oxygen to be controlled for the purpose of improving the output power of the engine.

Another aspect provided by the exemplary embodiments is the provision of an apparatus and method for compensating for loss of performance due to changes in altitude.

A further aspect that may be accomplished by the exemplary embodiments is the provision of an apparatus and method for altering the fuel to air ratio for optimizing the engine performance.

According to the exemplary embodiments of the present invention, then, a system for introducing auxiliary oxygen into an internal combustion engine is disclosed. Here, the internal combustion engine has an associated fuel supply in communication with an intake assembly that provides fuel and ambient air to the engine. Broadly, the exemplary embodiments of the present invention include a source of auxiliary oxygen and at least one dispensing outlet associated with the intake assembly. The exemplary embodiments also include a conduit that establishes fluid communication between the source of auxiliary oxygen and the dispensing outlet whereby a flow of oxygen from the source of auxiliary oxygen can be supplied to the intake assembly through the outlet. A controllable valve is then provided with this valve being associated with the conduit and that is operative to selectively vary the flow of auxiliary oxygen to the intake assembly.

According to the exemplary embodiments of the invention, the auxiliary oxygen is therefore introduced into the fuel/air intake flow of the intake assembly for the combustion engine. This could be at any location within the intake assembly or in the environment immediately adjacent the intake assembly.

In the disclosed embodiments, a storage reservoir is operative to store the auxiliary oxygen at an elevated pressure above the ambient. In these embodiments, it is contemplated that the auxiliary oxygen that is in the storage reservoir is in a substantially pure state. A pressure regulator may also be provided with this pressure regulator being interposed between a storage reservoir and a dispensing outlet. This pressure regulator is operative to control the pressure at which auxiliary oxygen is supplied to the intake assembly. In the disclosed embodiments, the regulator is adjustable whereby the pressure at which auxiliary oxygen is applied may be selectively varied.

The intake assembly may have a carburetor associated therewith. In such instance, the dispensing outlet may be in the carburetor. Alternatively, the intake assembly may have a throttle body associated therewith, the dispensing outlet may be in the throttle body. Where the intake assembly has an intake manifold body associated therewith, the dispensing outlet may alternatively be in the intake manifold.

While it is contemplated that a single dispensing outlet be sufficient, in some of the exemplary embodiments, a plurality of dispensing outlets are associated with the intake assembly with each of these dispensing outlets providing a flow of oxygen from the source of auxiliary oxygen to the intake assembly. The dispensing outlets can merely be exit ports of the conduit or specialized elements or injectors.

The controllable valve that is associated with the conduit can either be at an upstream location, at a downstream location or at any point in between, according to the exemplary embodiments. In any event, the valve can have an active state that permits the flow of oxygen and an inactive state that prohibits the flow of oxygen. A control switch is then provided that is operative to switch the valve between the active and inactive states. The control valve may be operated by an electrical solenoid that moves from a first position to a second position thereby to advance the valve from the inactive state to the active state and to return to the first position. The control switch is then an electrical switch electrically connected to a source of electrical power for the solenoid.

On one hand, the engine may be provided with mechanical throttle controls. The control switch can then be mounted relative to the throttle controls whereby movement of the throttle controls acts to operate the control switch. On the other hand, the control switch may be associated with a computerized engine control unit.

An optional override switch may be electrically connected in parallel to the control switch so that the operator may manually activate the system. In addition, an on/off master switch may be electrically connected in series with the control switch to deactivate the system from operation.

In any event, the present invention also concerns a method of increasing available oxygen in a combustion engine. This method may include any procedural step inherent in the structures described herein. Broadly, the exemplary embodiments provide a method for increasing available oxygen wherein the engine has an associate fuel supply, an intake assembly that provides fuel from the fuel supply and ambient to the engine. Moreover, throttle controls are normally associated with the intake assembly. These disclosed embodiments disclose a method that includes a first step of providing a source of auxiliary oxygen. The method then includes a second step of selectively introducing oxygen from the source of auxiliary oxygen to the intake assembly contemporaneously with the provision of ambient air. The method of the present invention may, if desired, include the step of selectively regulating the pressure of oxygen that is introduced into the intake assembly. The method contemplates that the auxiliary oxygen is in a substantially pure form. Further, in a more detailed form, the exemplary embodiments utilize a step of introducing oxygen from the source of auxiliary oxygen in response to activation of the throttle controls above a selected threshold.

### BRIEF DESCRIPTION OF THE DRAWINGS

FIG. 1 is a diagram of the system of the first exemplary embodiment of the present invention;

FIG. 2 is a sectional view of the carburetor and induction system of an internal combustion engine showing a first embodiment of the present invention;

FIG. 3 is a diagram of the system of the second embodiment of the present invention;

FIG. 4 is a sectional view of the throttle body and induction system of a fuel injected internal combustion engine, and

FIG. 5 is a diagram of the system of the third embodiment of the present invention.

### DETAILED DESCRIPTION OF THE EXEMPLARY EMBODIMENTS

The present invention is directed to a system for introducing auxiliary oxygen into the air induction system of an internal combustion engine for the improvement of engine performance. This not only adds additional oxygen for combustion but also displaces nitrogen. The exemplary systems disclosed herein generally include a storage tank containing auxiliary oxygen, a pressure regulator, control valve, control solenoid, hosing or other conduit interconnects, electrical wiring, a solenoid control switch, a master switch, and one or more dispensing outlets. The system is intended to be adaptable to an existing engine, or mounted onto a new engine, with the purpose of providing a more oxygen-rich airflow to the combustion chambers thereby allowing a larger mass of fuel to be combusted and thus providing more power per combustion cycle of the engine.

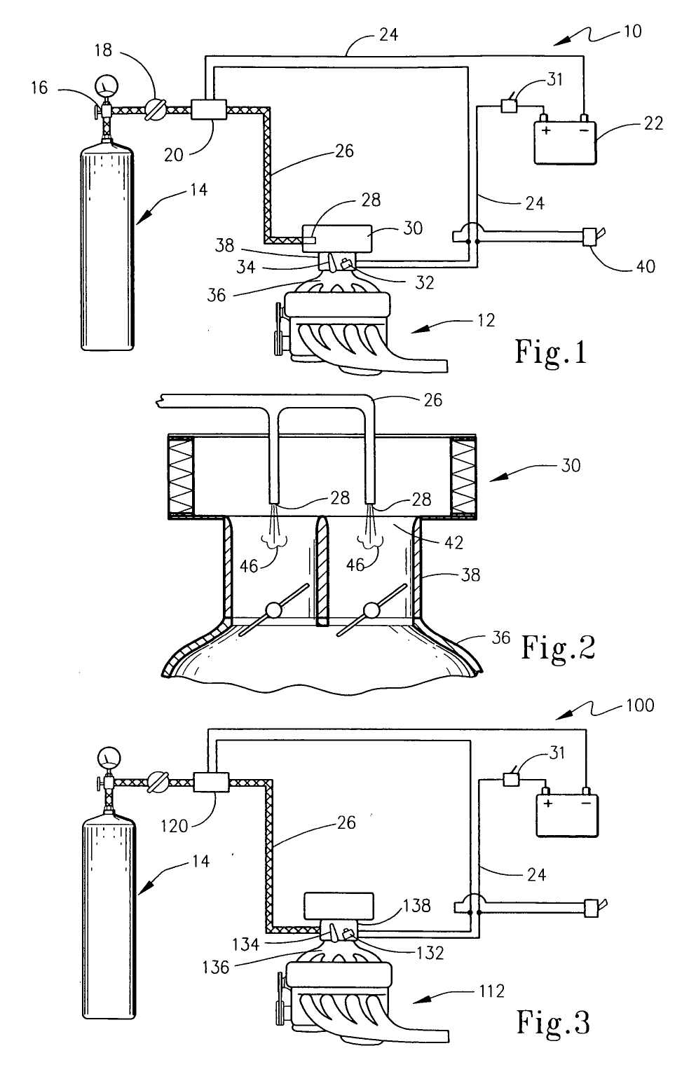

A first embodiment of the present invention is shown in FIGS. 1 and 2. A diagram of the system is shown in FIG. 1. Here it is seen that the oxygen induction system 10 works in conjunction with an internal combustion engine 12 that has an intake assembly that includes, for example, an air cleaner 30, a carburetor 38, and an intake manifold 36. The system 10 in this embodiment utilizes a compressed oxygen storage tank 14 that contains substantially pure compressed oxygen gas. Tank 14 is provided with pressure regulator 16 and control valve 18. The system 10 further includes a solenoid 20, electrical wiring 24, hose 26 having a dispensing outlet 28, an on/off master switch 31, and a control switch 32. Storage tank 14 is a pressure vessel which contains the compressed auxiliary oxygen in gaseous state and includes a pressure regulator 16 for selectively controlling the outlet pressure of the tank 14 and a control valve 18 for opening and closing the supply of gas to the rest of the system. This valve 18 is opened when the system is active and can be closed when replacing or recharging the tank 14 or when the system is not in use.

A solenoid valve 20 is connected to the control valve 18 and hose 26. The solenoid valve 20 is electrically switched between an active and an inactive state and is used to selectively turn on and off the flow of oxygen to the engine via the hose 26. An on/off master switch 31 is also included in the circuit to allow one the ability to enable or disable the system. A control switch 32 is also mounted onto the carburetor 38 of the engine 12. This control switch 32 is a momentary, electrical switch connected in electrical series with the solenoid 20 and a battery 22 (or other electrical power source) through the wiring 24 such that activation of the control switch 32 completes the circuit, energizes the solenoid 20 when switch 31 is active, and thereby allows the oxygen to flow through hose 26 and into the air cleaner 30 by way of the hose outlet 28.

In many vehicles, the fuel flow to the combustion chambers of the engine is controlled by the driver through mechanical throttle controls such as, for example, a “gas pedal”, a carburetor throttle arm and interconnecting linkage. In the exemplary embodiment shown in FIG. 1 the control switch 32 is mounted such that the carburetor throttle arm 34 contacts and closes the control switch 32 when the throttle arm 34 reaches a determined position, thereby initiating the introduction of the auxiliary oxygen from tank 14. In this embodiment, a manual control switch 40 is electrically connected in parallel with the control switch 32. Manual override switch 40 is an on-off switch which would allow the operator to manually control the activation of the oxygen introduction in lieu of relying on the throttle position activated control switch 32 when master switch 31 is active.

The flow rate of the oxygen into the engine 12 is controlled by the pressure regulator 16. A higher pressure produces a higher flow rate which, in turn, adds more oxygen to the intake air stream. In this manner, the performance increase is determined by the pressure setting of the regulator 16. The specific pressure required for a certain performance level is dictated by the size and type of engine 12, the location of the outlet 28 with respect to the flow characteristics of the engine's air intake system, and the size of the hose 26 and outlet 28 utilized. Regulator 16 may be set to provide oxygen at a convenient pressure, for example, 40 to 80 pounds per square inch. One skilled in the art can appreciate that the individual components discussed here are all commercially available items.

As can be seen in FIG. 1, the hose 26 is connected to the air cleaner 30 and positioned such that its outlet 28 releases the oxygen to the interior of air cleaner 30 where it mixes with the incoming air before entering the carburetor 38. FIG. 2 better shows this. This figure shows a sectional view of the carburetor 38, with entrance 42, and a portion of the intake manifold 36. Here it can be seen that the hose 26 and one or more outlets 28 are mounted onto the air cleaner 30 and the outlets 28 are positioned near the entrance 42 of the carburetor 38 such that the exiting oxygen jet 46 flows, along with air, into the carburetor 38 when the solenoid 20 is opened. The outlets 28 are positioned such that the exiting oxygen is entrained in the air flow and captured by the carburetor 38.

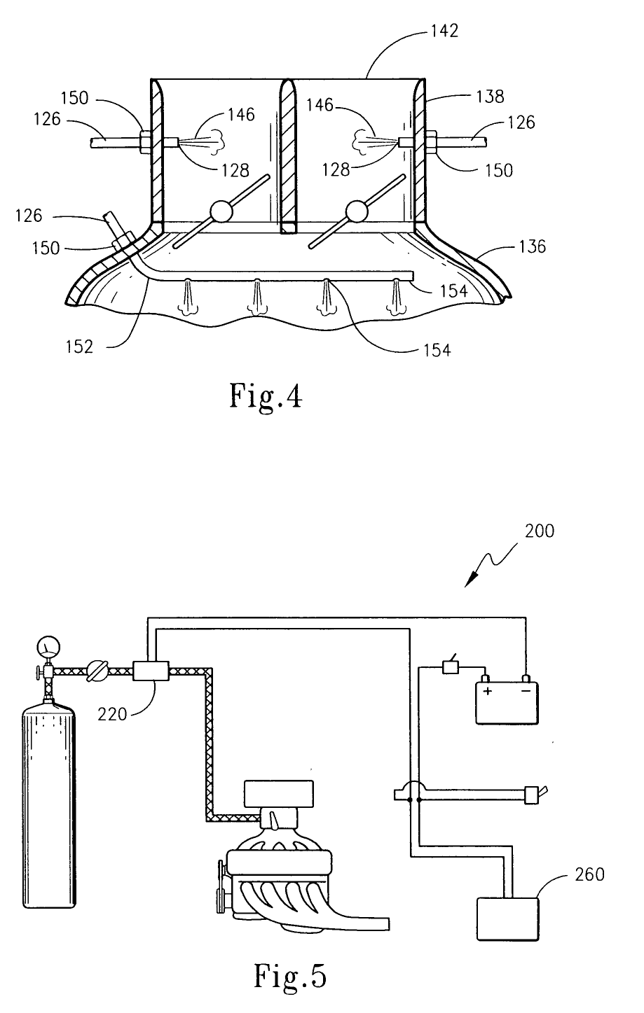

A second embodiment of the present invention 100 addresses the application to fuel-injected internal combustion engines. FIG. 3 shows the diagram for this embodiment, which is similar to that shown in FIG. 1. Fuel-injected engines use a different scheme for delivering the fuel to the air mixture and utilize a throttle body 138 in place of a carburetor 38 (shown in FIGS. 1 and 2) for controlling the fuel/air intake flow into the engine 112. With this exception, the other components shown in FIG. 3 are the same as those shown in FIG. 1. The present invention's concept of adding auxiliary oxygen to the fuel/air flow applies equally well to fuel-injected engines. FIG. 4 shows a sectional view, similar to that of the carburetor 38 in FIG. 2, of the throttle body 138 and intake manifold 136. The hose 126 and one or more outlets 128 may be located in one or a number of positions in the throttle body 138 or within the intake manifold 136 to accomplish this. As depicted in FIG. 4, the outlets 128 may be mounted into the throttle body 138 itself and attached with connectors 150 to hose 126. In addition to, or alternatively, an injector tube 152 with outlets 154 may be mounted within the intake manifold 136 and positioned to provide optimum distribution and mixing of the oxygen with air. Also identical to the first embodiment, the activation of the solenoid 120 can be controlled by a switch 132 positioned to be turned on when the throttle arm 134 reaches a specific position, as shown in FIG. 3.

Most modern fuel-injection systems utilize an engine control unit to monitor and control the engine's operation. This engine control unit is a micro-processor computer which monitors a variety of engine sensors, usually including an exhaust gas oxygen sensor, evaluates their inputs, and controls the operation of the engine accordingly. FIG. 5 shows a third embodiment of the present invention 200. The components shown here are similar to those shown in FIGS. 1 and 3 with the exception that the activation of the solenoid 220 is controlled by the engine control unit 260 in place of the control switch 32 as shown in the first embodiment (FIG. 1) or control switch 132 for the second embodiment (FIG. 3). In this embodiment, the engine control unit 260 is adapted to provide the control of the activation of the solenoid 220 based on the engine's operating parameters thereby eliminating the need for the control switch 32 of the first embodiment or 132 of the second. In applications where the auxiliary oxygen system is added to an existing engine with fuel injection, the engine control unit can adapt to the increased oxygen in the intake airflow and automatically provide additional fuel to the engine thus producing more power.

From the foregoing descriptions of the exemplary embodiments, it should be appreciated that the auxiliary oxygen can be introduced into the fuel/air intake flow for the engine at various locations. The introduction could be into the region of the air filter, into the carburetor (or corresponding structure for a fuel injected engine), into the intake manifold of the engine, or otherwise so as to be drawn into the intake flow, including introducing the auxiliary oxygen into the engine compartment environment such as adjacent to the air filter intake. Thus, the use of the phrase “fuel/air intake flow” is intended to encompass, without limitation, these and all such other locations where oxygen from the ambient environment can ultimately enter the combustion chambers. The “dispensing outlets” can be outlets for the auxiliary air flow or more specialized injectors. The control switch can be any structure or system (such as a computer control) that acts to control the valve that in turn controls the rate of flow of the auxiliary oxygen to the combustion chambers. “Throttle controls” may mean any of those structures or systems that are employed to control the supply of fuel or air to the combustion chambers. Further, it is contemplated that, by referring to a “source of auxiliary oxygen”, such source can be a reservoir (such as a storage tank) or other assembly that can provide auxiliary oxygen.

In any event, the present invention also concerns a method of increasing available oxygen in a combustion engine. This method may include any procedural step inherent in the structures described herein. Broadly, the exemplary embodiments provide a method for increasing available oxygen wherein the engine has an associate fuel supply, an intake assembly that provides fuel from the fuel supply and ambient to the engine. The method that includes a first step of providing a source of auxiliary oxygen. The method then includes a second step of selectively introducing oxygen from the source of auxiliary oxygen to the intake assembly contemporaneously with the provision of ambient air.

The method of the present invention may, if desired, include a step of selectively regulating the pressure of oxygen that is introduced into the intake assembly. The method contemplates that the auxiliary oxygen is in a substantially pure form. Further, where there are throttle controls associated with the intake assembly, the exemplary embodiments utilize a step of introducing oxygen from the source of auxiliary oxygen in response to activation of the throttle controls above a selected threshold.

Accordingly, the present invention has been described with some degree of particularity directed to the exemplary embodiments of the present invention. It should be appreciated, though, that the modifications or changes may be made to the exemplary embodiments of the present invention without departing from the inventive concepts contained herein.

I claim:

1. A system for introducing auxiliary oxygen into a combustion engine with an associated fuel supply in communication with an intake assembly that provides fuel and ambient air to the engine, comprising:
(A) a source of auxiliary oxygen;
(B) at least one dispensing outlet associated with the intake assembly;
(C) a conduit establishing fluid communication between said source of oxygen and said dispensing outlet whereby a flow of oxygen from said source of auxiliary oxygen can be supplied to the intake assembly through said outlet; and
(D) a controllable valve associated with said conduit and operative to selectively vary the flow of auxiliary oxygen to said intake assembly.

2. A system according to claim 1 including a storage reservoir operative to store the auxiliary oxygen at an elevated pressure above ambient pressure.

3. A system according to claim 2 wherein the auxiliary oxygen in said storage reservoir is substantially pure.

4. A system according to claim 2 including a pressure regulator interposed between said storage reservoir and said outlet, said pressure regulator operative to control the pressure at which auxiliary oxygen is supplied to the intake assembly.

5. A system according to claim 4 wherein said regulator is adjustable whereby the pressure at which auxiliary oxygen is supplied to the intake assembly may be selectively varied.

6. A system according to claim 1 wherein the intake assembly has a carburetor associated therewith, said outlet being in said carburetor.

7. A system according to claim 1 wherein the intake assembly has a throttle body associated therewith, said outlet being in said throttle body.

8. A system according to claim 1 wherein the intake assembly has an intake manifold body associated therewith, said outlet being in said intake manifold.

9. A system according to claim 1 including a plurality of dispensing outlets associated with the intake assembly whereby a flow of oxygen from said source of auxiliary oxygen can be supplied to the intake assembly through each of said outlets.

10. A system according to claim 1 wherein said valve has an active state permitting flow of oxygen from said source of auxiliary oxygen to said intake assembly and an inactive state prohibiting the flow of oxygen from said source of auxiliary oxygen to said intake assembly, and including a control switch operative to switch said valve between the active and inactive states.

11. A system according to claim 10 wherein said control switch is associated with a computerized engine control unit.

12. A system according to claim 10 wherein the engine includes mechanical throttle controls associated therewith, said control switch being mounted relative to the throttle controls whereby movement of the throttle controls acts to operate said control switch.

13. A system according to claim 10 including an electrically operable solenoid operative to move from a first position to a second position thereby to advance said valve from the inactive state to the active state and to return to the first position, said control switch being an electrical switch electrically connected to a source of electrical power for said solenoid.

14. A system according to claim 13 including an override switch electrically connected in parallel to said control switch.

15. A system according to claim 13 including an on/off master switch electrically connected in series with said control switch.

16. A system for introducing auxiliary oxygen into a fuel/air intake flow of an intake assembly of a combustion engine that normally provides fuel and ambient air to the engine, comprising:
(A) a storage reservoir adapted to store auxiliary oxygen at an elevated pressure above ambient air pressure and to supply the auxiliary oxygen to at least one dispensing outlet in fluid communication with the fuel/air intake flow;
(B) a conduit establishing fluid communication between said storage reservoir and said dispensing outlet whereby auxiliary oxygen can be supplied to the fuel/air intake flow through said outlet;
(C) an adjustable pressure regulator interposed between said storage reservoir and said outlet, said pressure regulator operative to selectively control the pressure at which auxiliary oxygen is supplied to the fuel/air intake flow;
(D) a controllable valve associated with said conduit and operative to selectively vary the flow of auxiliary oxygen to said intake assembly.

17. A system according to claim 16 including a plurality of dispensing outlets associated with the intake assembly whereby auxiliary oxygen can be supplied to the fuel/air intake flow through each of said outlets.

18. A system according to claim 16 wherein said valve has an active state permitting flow of oxygen from said source of auxiliary oxygen to said intake assembly and an inactive state prohibiting the flow of oxygen from said source of auxiliary oxygen to said intake assembly, and including a control switch operative to switch said valve between the active and inactive states.

19. A system according to claim 18 wherein the engine includes mechanical throttle controls associated therewith, said control switch being mounted relative to the throttle controls whereby movement of the throttle controls acts to operate said control switch.

20. A system according to claim 18 including an electrically operable solenoid operative to move from a first position to a second position thereby to advance said valve from the inactive state to the active state and to return to the first position, said control switch being an electrical switch electrically connected to a source of electrical power for said solenoid.

21. A system according to claim 20 including an override switch electrically connected in parallel to said control switch and an on/off master switch electrically connected in series with said control switch.

22. A method for increasing available oxygen for combustion in a combustion engine, wherein said engine has an associated fuel supply, an intake assembly that provides fuel from the fuel supply and ambient air to the engine, and throttle controls associated with said intake assembly, comprising:
(A) providing a source of auxiliary oxygen; and
(B) selectively introducing oxygen from said source of auxiliary oxygen into the intake assembly contemporaneously with the provision of ambient air.

23. A method according to claim 22 including the step of selectively regulating the pressure of oxygen that is introduced into the intake assembly.

24. A method according to claim 22 wherein the auxiliary oxygen is substantially pure.

25. A method according to claim 22 wherein the step of introducing oxygen from said source of auxiliary oxygen occurs in response to activation of said throttle controls to supply air or fuel at an amount above a selected threshold.
